(19) United States
(12) Patent Application Publication
(10) Pub. No.: US 2010/0258421 A1
(43) Pub. Date: Oct. 14, 2010

(54) CONTROL KEY AND ELECTRONIC DEVICE USING THE SAME

(75) Inventors: LI-LONG CHEN, Shenzhen City (CN); MING WEI, Shenzhen City (CN); YUN-FANG LIU, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/504,786

(22) Filed: Jul. 17, 2009

(30) Foreign Application Priority Data
Apr. 13, 2009 (CN) 200910301537.0

(51) Int. Cl. H01H 13/14

(52) U.S. Cl. 200/341

(57) ABSTRACT

A key for electronic device includes a support body and an operating body. The support body forms a plurality of connecting pins. The support body and the operating body are integrally formed. The operating body defines a plurality of grooves in the side surface adjacent to the support body. The grooves are configured for receiving a plurality of knockout pins of a multi-shot mold in a multi-shot molding process.

### BACKGROUND

1. Technical Field

The present disclosure relates generally to control keys and, more particularly, to a control key for an electronic device and an electronic device utilizing the key.

2. Description of Related Art

Electronic devices generally have a plurality of keys for conveniently operating the electronic devices. The keys correspond to different functions, such as taking photographs and adjusting the volume.

A typical key includes a support body connected to an operating body. The support body is positioned at a side of a circuit board of the electronic device. A contact pin is formed on the support body, and faces the circuit board. Pressing the support body impels the contact pin to electrically connect to the circuit board, thus operating the electronic device. The support body and the operating body are generally integrally formed by a multi-shot mold or glued together.

However, when the operating body is glued to the support body, resulting bonding strength between the operating body and the support body is relatively poor, and considerable time is required for bonding thereof. When the operating body and the support body are molded together to form the key, a connecting protrusion is formed therebetween, such that the key is easily disengaged from the multi-shot mold by pushing the connecting protrusion. However, the support body of the key is generally thin, and easily damaged by a knockout pin of the multi-shot mold during disengagement from the mold.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an assembled, isometric view of an exemplary embodiment of an electronic device using a control key.

FIG. 2 is an exploded, isometric view of the electronic device of FIG. 1.

FIG. 3 is an isometric view of a control key for an electronic device, such as, for example, the device of FIG. 1.

FIG. 4 is similar to the FIG. 3, but viewed from another aspect.

### DETAILED DESCRIPTION

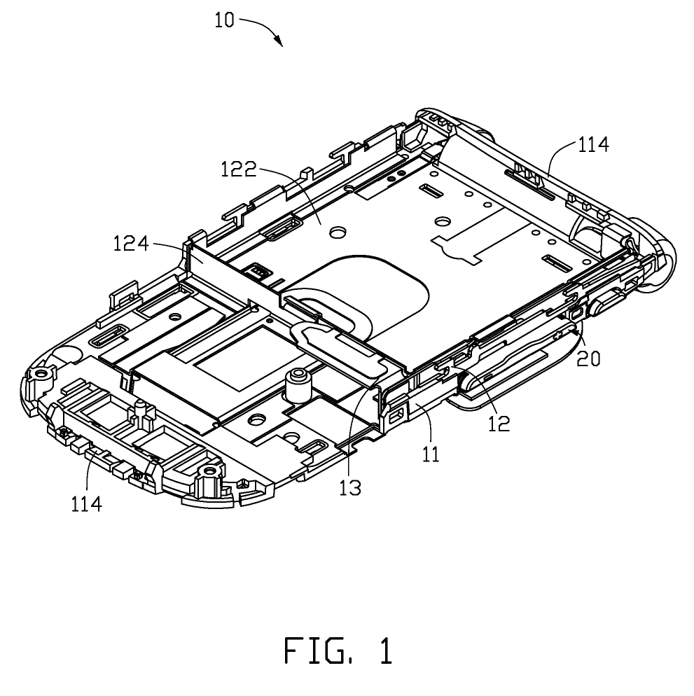

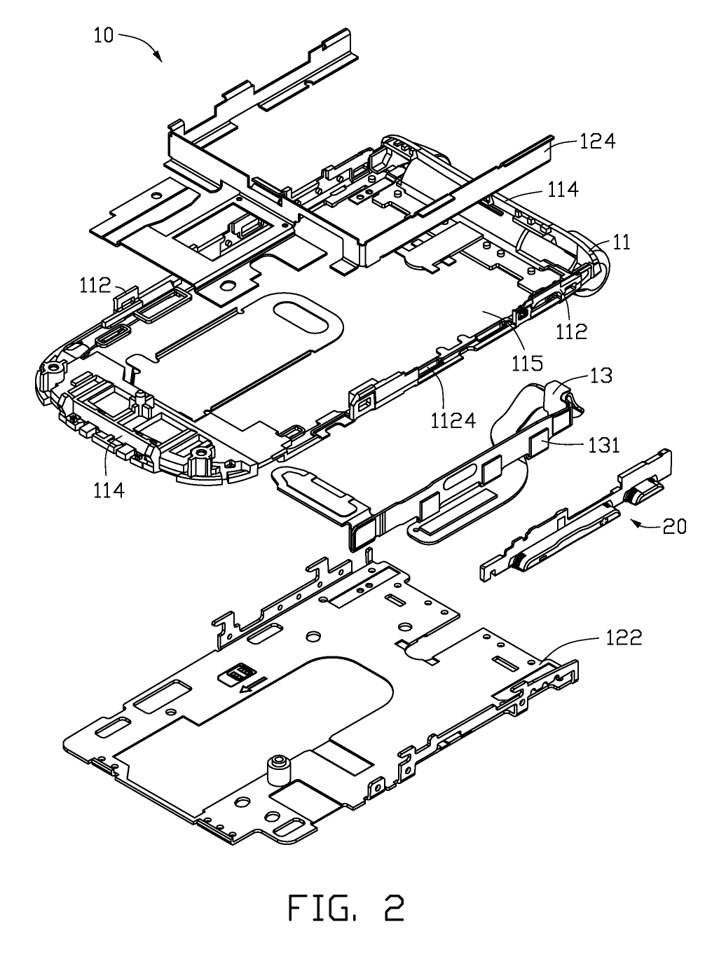

Referring to FIGS. 1 and 2, an exemplary embodiment of an electronic device 10 includes a housing 11, a fixing assembly 12, a side circuit board 13, a key 20, a main circuit board (not shown), a battery (not shown), and a display body (not shown). In the illustrated embodiment, the electronic device 10 is a mobile phone. The key 20 is a side control key.

The housing 11 includes two opposite first sidewalls 112 and two opposite second sidewalls 114. The first sidewalls 112 and the second sidewalls 114 define a receiving groove 115 receiving the main circuit board, the battery, and the display body. One first sidewall 112 defines three assembly cutouts 1124. The fixing assembly 12 includes a first fixing plate 122 and a second fixing plate 124, configured to fix the display body and the battery. One or more switches 131 are formed on the side circuit board 13. In the exemplary embodiment, three switches 131 are formed on the side circuit board 13. The side circuit board 13 is electrically connected to the main circuit board.

The key 20 includes a support body 21 and an operating body 23. The support body 21 and the operating body 23 are integrally formed by multi-shot molding. The support body 21 is a substantially flat plate, and includes a first surface 212 and a second surface 213 opposite to the first surface 212. The operating body 23 is formed on the first surface 212 of the support body 21. The operating body 23 includes a first contact portion 231 and a second contact portion 232. The first contact portion 231 includes a first contact end 2312 and a second contact end 2314, configured to adjust the volume of the electronic device 10. The second contact portion 232 may be configured to turn a camera function on and off. One or more connecting pins 2132 may be formed on the second surface 213 of the support body 21, corresponding to the first contact portion 231 and the second contact portion 232. Here, three connecting pins 2132 are formed on the second surface 213 of the support body 21. A plurality of positioning protrusions 2134 may be also formed on the second surface 213.

The first contact portion 231 defines a first groove 2315 and a second groove 2316 in a side surface adjacent to the support body 21. The second contact portion 232 defines a third groove 2325 and a fourth groove 2326 adjacent to the support body 21. The first groove 2315, the second groove 2316, the third groove 2325, and the fourth groove 2326 are substantially aligned in a straight line parallel to the support body 21, and configured for receiving knockout pins (not shown) of a multi-shot mold (not shown), so that the key 20 is easily dislodged from the multi-shot mold.

The support body 21 may be elastic material such as thermoplastic rubber, thermoplastic polyurethane, or a combination. The operating body 23 may be rigid material such as acrylonitrile butadiene styrene copolymer, polycarbonate, or a combination.

During multi-shot mold manufacture, the operating body 23 is formed in the multi-shot mold, and the support body 21 is further formed on a side of the operating body 23. After the key 20 is formed, two knockout pins are inserted into the first groove 2315 and the second groove 2316, and slide to ends of the first contact portion 231 respectively to dislodge first contact portion 231 from the multi-shot mold. At the same time, two knockout pins are inserted into the third groove 2325 and the fourth groove 2326, and slide to ends of the second contact portion 232 respectively for dislodging the second contact portion 232 from the multi-shot mold.

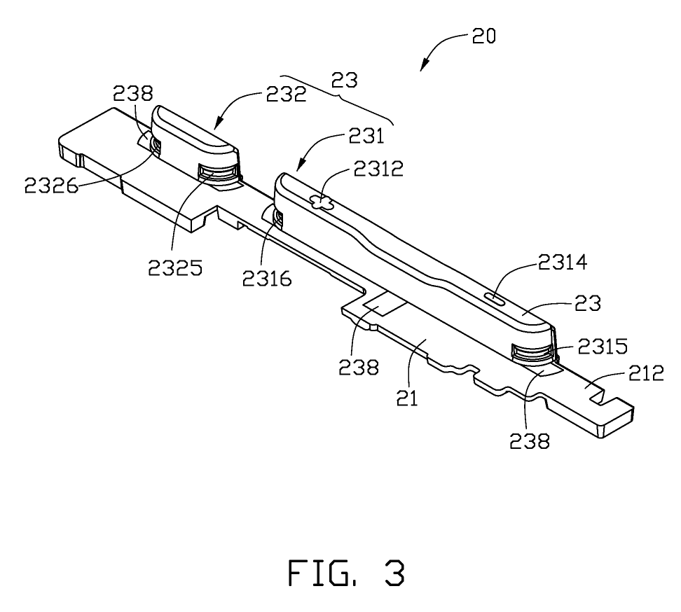

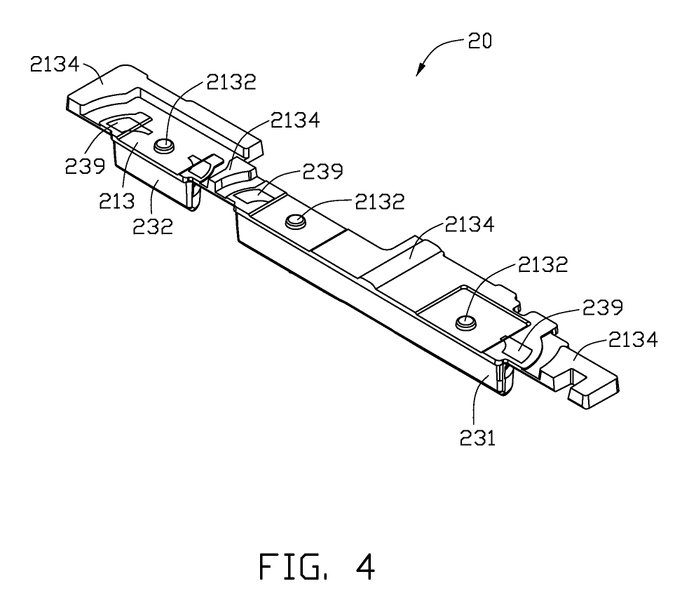

Since the operating body 23 is thicker than the support body 21, the operating body 23 has sufficient strength to withstand damage when the knockout pins resist the operating body 23. In addition, a plurality of flanges 238 (as shown in FIG. 3) are formed around the first contact portion 231 and the second contact portion 232. The flanges 238 engage the support body 21 to enhance bonding force between the support body 21 and the operating body 23. A plurality of connecting portions 239 (as shown in FIG. 4) are formed on the operating body 23. The support body 21 correspondingly defines a plurality of grooves (not labeled) receiving the connecting portions 239, so as to further enhance a bonding force between the support body 21 and the operating body 23.

Referring to FIGS. 1 through 4, in assembling the electronic device 10, the key 20 is positioned on the first sidewall 112, with the first contact portion 231 and the second contact portion 232 engaging the assembly cutouts 1124. The side circuit board 13 is positioned on the housing 11, and the connecting pins 2132 correspond to the switches 131. The first fixing plate 122 and the second fixing plate 124 are positioned on opposite surfaces of the housing 11, thus firmly fixing the support body 21 and the side circuit board 13 to the housing 11.

In use, when the first contact portion 231 and the second contact portion 232 are subject to external force, the support body 21 deforms, and the connecting pins 2132 of the key 20 contact the corresponding switches 131 of the side circuit board 13. Accordingly, the side circuit board 13 generates a control signal to implement functions such as camera or volume adjustment. When the external force is released, the support body 21 returns to a normal state. The connecting pins 2132 withdraw from the switches 131 of the side circuit board 13.

It should be pointed out that the side circuit board 13 may be integrally formed with the main side circuit board 13. In addition, the operating body 23 may define one or more grooves to receive the knockout pins of the multi-shot mold.

The support body 21 is elastic, so as to absorb collision force between the connecting pins 2132 and the switches 131. Thus, the side circuit board 13 is protected from damage by the connecting pins 2132, and the key 20 comfortably operated. The operating body 23 is rigid, withstanding repeated use.

It is believed that the disclosure and its advantages will be understood from the foregoing description, and it will be apparent that various changes may be made thereto without departing from the spirit and scope of the disclosure or sacrificing all of its material advantages.

What is claimed is:

1. A key, comprising:
a support body defining at least one connecting pin; and
an operating body;
wherein the support body and the operating body are integrally formed, and the operating body defines at least one groove in a side surface adjacent to the support body, the at least one groove configured for receiving at least one knockout pin of a multi-shot mold in a multi-shot molding process.

2. The key of claim 1, wherein the support body is made of elastic materials.

3. The key of claim 2, wherein the support body is made of thermoplastic rubber, thermoplastic polyurethane, or a combination thereof.

4. The key of claim 1, wherein the operating body is made of acrylonitrile butadiene styrene copolymer, polycarbonate, or a combination thereof.

5. The key of claim 1, wherein a plurality of flanges are formed around the operating body, engaging the support body to enhance a bonding force between the support body and the operating body.

6. The key of claim 1, wherein a plurality of connecting portions formed on the operating body engage the support body to enhance bonding between the support body and the operating body.

7. The key of claim 1, wherein the operating body comprises a first contact portion and a second contact portion; the first pressing defines two grooves in the side surface, and the second contact portion defines two grooves in the side surface.

8. The key of claim 7, wherein the grooves of the first contact portion and the second contact portion are substantially aligned in a straight line parallel to the support body.

9. The key of claim 1, wherein the support body is a substantially flat plate, and comprises a first surface and a second surface opposite to the first surface, wherein the operating body is formed on the first surface, and the at least one connecting pin is formed on the second surface.

10. An electronic device, comprising:
a housing;
a side circuit board positioned on the housing, comprising at least one switch;
a key positioned on the housing, and adjacent to the side circuit board, the key comprising:
a support body defining at least one connecting pin corresponding to the at least one switch; and
an operating body;
wherein the support body and the operating body are integrally formed, and the operating body defines at least one groove in a side surface adjacent to the support body.

11. The electronic device of claim 10, wherein the support body is made of elastic materials.

12. The electronic device of claim 11, wherein the support body is made of thermoplastic rubber, thermoplastic polyurethane, or a combination thereof.

13. The electronic device of claim 10, wherein the operating body is made of acrylonitrile butadiene styrene copolymer, polycarbonate, or a combination thereof.

14. The electronic device of claim 10, wherein a plurality of flanges are formed around the operating body, engaging the support body to increase engaging force between the support body and the operating body.

15. The electronic device of claim 10, wherein a plurality of connecting portions are formed on the operating body, engaging the support body, to further increase engaging force between the support body and the operating body.

16. The electronic device of claim 10, wherein the operating body comprises a first contact portion and a second contact portion; the first pressing defines two grooves in the side surface, and the second contact portion defines two grooves in the side surface.

17. The electronic device of claim 16, wherein the grooves of the first contact portion and the second contact portion are substantially aligned in a straight line parallel to the support body.

18. The electronic device of claim 16, wherein the first contact portion comprises a first contact end and a second contact end to adjust the volume of the electronic device.

19. The electronic device of claim 10, wherein the support body is a substantially flat plate, and comprises a first surface and a second surface opposite to the first surface, the operating body is formed on the first surface, and the at least one connecting pin is formed on the second surface.
